(19) United States
(12) Patent Application Publication
(10) Pub. No.: US 2016/0168952 A1
(43) Pub. Date: Jun. 16, 2016

(54) TAGGED PARAFFIN INHIBITORS AND ASPHALTENE INHIBITORS FOR USE IN SUBTERRANEAN OPERATIONS

(71) Applicant: MULTI-CHEM GROUP, LLC, San Angelo, TX (US)

(72) Inventors: LIANGWEI QU, THE WOODLANDS, TX (US); YING JIANG, PEARLAND, TX (US)

(21) Appl. No.: 14/908,440

(22) PCT Filed: May 16, 2014
(86) PCT No.: PCT/US14/38389

§ 371 Date: Jan. 28, 2016

(51) Int. Cl. E21B 37/06; E21B 49/08; G01V 8/10; C09K 8/524; G01N 21/73

(52) U.S. Cl. CPC E21B 37/06; C09K 8/524; G01N 21/73; G01V 8/10; E21B 49/08

(57) ABSTRACT

Improved compositions, treatment fluids, and methods for providing paraffin inhibition in subterranean operations, pipelines, and other related operations are provided. In one embodiment, the methods comprise: providing a tagged inhibitor that comprises a base compound capable of inhibiting precipitation of paraffins or asphaltenes bonded with a detectable moiety; and introducing the tagged inhibitor into at least a portion of a subterranean formation.

### BACKGROUND

The present disclosure relates to treatment fluids and methods for providing paraffin inhibition in subterranean operations, pipelines, and other related operations.

Crude oil produced from subterranean formations typically contains many kinds of hydrocarbons, including paraffin wax. Paraffin wax is typically dissolved crude oil at higher temperatures and/or pressures. However, paraffin wax tends to precipitate from crude oil in waxy solid deposits when the pressure and temperature is lowered as the hydrocarbon is produced and as the crude oil cools down. Paraffin wax deposition in well bores, tubing, and/or pipelines may obstruct the flow of oil and/or other fluids, lowering oil production and interfering with transportation.

Asphaltenes are also a problem in crude oil production in many areas around the world. Asphaltenes may precipitate as solids in the matrix of the formation, in a previously-created fracture in the formation, in the wellbore, or in production tubing. Asphaltenes that precipitate in the formation can result in plugging of the pores in the matrix subterranean formation.

Removal and/or inhibition of paraffin wax and asphaltene deposits is typically attempted using various mechanical, thermal, or chemical means (or some combination thereof). As used herein, the term “inhibit” and its derivatives refer to a lessening of the tendency of a phenomenon to occur and/or the degree to which that phenomenon occurs. The term “inhibit” does not imply any particular degree or amount of inhibition. The main mechanical approach for helping to clean a pipeline, including for removing paraffin buildup, is to run a mechanical device (e.g., a “pig” or paraffin scratcher or scraper) through the pipeline that scrapes the inner wall of the pipeline and pushes the paraffin through. The device is normally driven through the pipeline by a relatively high pumping pressure behind the device, which is used to force the pig through the pipeline. However, if paraffin buildup on the inner walls of the pipeline is heavy, as the device moves forward it will collect so much paraffin in front of the moving device that it blocks any further movement of the device, plugging the pipeline. Moreover, these techniques are typically unsuitable for use in a subterranean formation or well bore. In thermal techniques, heated oil and/or water also may be pumped through production tubulars to reduce paraffin deposition, but these methods also may not be suitable for subterranean tubulars. Certain pipelines where paraffin deposition occurs also may be heated. However, these techniques are often very costly, and may not be feasible for subsea pipelines that are in direct contact with the surrounding cold seawater.

Chemical paraffin and asphaltene treatment additives have also been injected into tubulars, pipelines, and/or subterranean formations to remove paraffin wax and/or to reduce or substantially prevent deposition of paraffin wax in pipelines and tubulars, all with varying levels of success. Such paraffin treatment additives include solvents, surfactants, dispersants, crystal modifiers, and the like. However, these paraffin inhibitors are not always effective, for example, if they are not placed in the desired locations and/or are not delivered to the desired locations at sufficiently high concentrations. In some cases, certain types of tracer materials such as radioactive materials, fluorescing materials, and iodine have been included in the same fluid as the paraffin or asphaltene inhibitor to monitor their location. However, the accuracy of these tracers is often uncertain, for example, since the tracers often have different solubilities from that of the paraffin or asphaltene inhibitor.

### BRIEF DESCRIPTION OF THE FIGURES

These drawings illustrate certain aspects of some of the embodiments of the present disclosure, and should not be used to limit or define the disclosure.

FIG. 1 is a diagram illustrating an injection system that may be used in accordance with certain embodiments of the present disclosure.

While embodiments of this disclosure have been depicted and described and are defined by reference to example embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

Illustrative embodiments of the present disclosure are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time-consuming, but would nevertheless be a routine undertaking for those of ordinary skill in the art having the benefit of the present disclosure.

The present disclosure relates to compositions, treatment fluids and methods for providing paraffin inhibition in subterranean operations, pipelines, and other related operations. Specifically, the methods and compositions of the present disclosure generally involve the synthesis and use of paraffin and/or asphaltene inhibiting additives that are tagged with one or more detectable moieties (i.e., a detectable element or functional group) so that they may be traced for residual concentrations using various analytical methods when placed in those locations. The tagged inhibitors of the present disclosure generally comprise a base compound that is capable of inhibiting and/or preventing the precipitation of paraffins and/or asphaltenes bonded with a detectable element or functional group. In the methods of the present disclosure, a tagged inhibitor of the present disclosure may be placed in or near a subterranean formation, well bore, pipeline, or other location where paraffin and/or asphaltene inhibition is desired. The residual amount and/or concentration of the tagged inhibitor in a specific location then may be determined by analyzing fluid samples from that location (e.g., the well bore or pipeline) and determining the concentration of the detectable element or functional group.

The methods, compositions, and additives of the present disclosure may, among other benefits, provide a monitoring tool for establishing effective treatment rates for paraffin and/or asphaltene inhibitors where conventional monitoring methods cannot be used, and may do so more accurately, reliably, and efficiently even where such conventional methods are available. In certain embodiments, the enhanced monitoring techniques enabled by the methods, compositions, and additives of the present disclosure may lead to decreased failure rates due to inadequate treatment, and/or may reduce cost incurred by overtreatment to avoid failures. The methods, compositions, and additives of the present disclosure also may reduce operator cost by eliminating the need for time-consuming monitoring methods and lost time and resources due to inaccurate monitoring. The methods, compositions and additives of the present disclosure also may decrease the uncertainty of inhibitor transport in certain applications involving pipelines, liquid-producing wells, annulus drip applications, capillary strings, umbilical lines, batch treatments, gas lift applications, and the like.

The base paraffin and/or asphaltene inhibiting compounds used in the methods and compositions of the present disclosure may comprise any compound that inhibits the precipitation of paraffin wax or asphaltenes. Examples of such base compounds that may be suitable for use include, but are not limited to polyacrylates, maleic anhydrides, ethyl vinyl acetates, olefin/maleic esters, olefin/maleic imides, alky phenol resins, and derivatives and copolymers thereof. Other examples of base paraffin and/or asphaltene inhibiting compounds may include certain surfactants, dispersants, and the like. The base compound may be provided as a reagent, or may be generated in the synthesis process.

The detectable elements and functional groups used in the methods and compositions of the present disclosure may comprise any element or functional group that is not generally found in subterranean formations or produced water, or is only present in low concentrations. Examples of detectable elements that may be used include, but are not limited to, boron, phosphorus, bromine, iodine, selenium, and combinations thereof. In certain embodiments, the detectable element may be provided as a component of another compound or reagent to be reacted with the base compound or its precursors. For example, boron may be provided in one or more borates, such as boric acid, borax, and the like.

The tagged inhibitors of the present disclosure may be synthesized by any means known in the art. An example of a synthesis scheme that may be used to synthesize tagged inhibitors of the present disclosure is illustrated in Scheme 1 below.

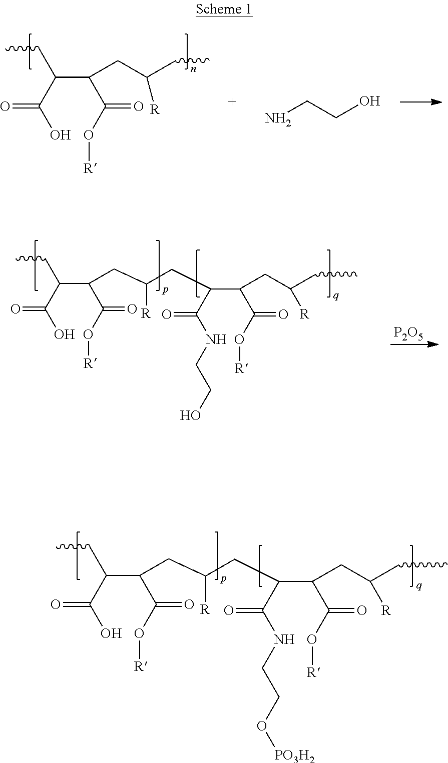

Scheme 1 reacts an alpha-olefin/maleic anhydride copolymer with phosphorus pentoxide to yield an alpha-olefin/maleic anhydride copolymer tagged with a phosphorus ester. Another example of a synthesis scheme that may be used to synthesize a tagged inhibitor of the present disclosure is illustrated in Scheme 2 below.

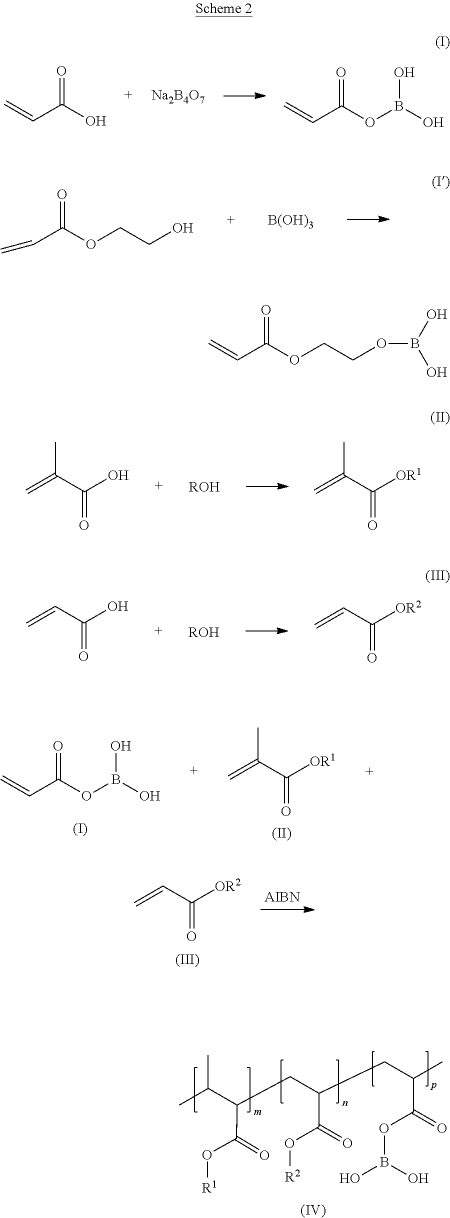

In Scheme 2, the tagged inhibitor IV is prepared by copolymerizing monomers I (or I′), II, and III in solution at certain ratios using an azobisisobutyronitrile (AIBN) radical initiator.

The ratios of the various reagents in the synthesis schemes shown above (e.g., monomers to be copolymerized) may be varied to produce tagged inhibitors having different structures and/or to produce a higher or lower yield of tagged inhibitor. For example, the ratio of the monomers shown in Scheme 2 above may vary depending on, among other things, the desired concentration of tagged inhibitor, minimum detection limits of the detectable element or functional group, and other factors. A person of skill in the art, with the benefit of this disclosure, will recognize how to vary those amounts to produce the desired tagged compounds and structures.

The molar concentration or amount of a tagged inhibitor used in the methods and compositions of the present disclosure may be similar to those used in conventional uses of the un-tagged base compounds as paraffin and/or asphaltene inhibitors, although the amount or concentration of the inhibitor by mass, once tagged with the detectable element or functional group, may be higher than the amounts of un-tagged base compound used conventionally. In certain embodiments, the tagged inhibitors of the present disclosure may be introduced into a solution or fluid (e.g., a fluid in a pipeline) in a concentration of from about 50 parts per million (“ppm”) to about 2000 ppm. In certain embodiments, a tagged inhibitor of the present disclosure may be used in combination with one or more additional paraffin and/or asphaltene inhibitors, including but not limited to inhibitors that are not tagged with a detectable element or functional group.

The inhibitors of the present disclosure may be introduced in a subterranean formation and/or well bore in conjunction with one or more treatment fluids. Such treatment fluids may comprise any treatment fluid known in the art (e.g., treatment fluids suitable for use in subterranean formations). As used herein, the term “treatment fluid” refers to any fluid that may be used in an application in conjunction with a desired function and/or for a desired purpose. The term “treatment” does not imply any particular action by the fluid or any component thereof. The treatment fluids of the present invention generally comprise a base fluid and, in certain embodiments, comprise one or more acids. Examples of common treatment fluids include, but are not limited to, drilling fluids, spacer fluids, completion fluids, and work-over fluids. Treatment fluids of the present disclosure optionally may comprise any number of additional additives in combination with the catechol component and amine component. Other examples of such additional additives include, but are not limited to, weighting agents, surfactants, emulsifiers, acids, fluorides, fluid loss control additives, gas, nitrogen, carbon dioxide, surface modifying agents, tackifying agents, foamers, corrosion inhibitors, scale inhibitors, catalysts, clay control agents, biocides, friction reducers, antifoam agents, bridging agents, dispersants, flocculants, additional H₂S scavengers, CO₂ scavengers, oxygen scavengers, lubricants, viscosifiers, breakers, relative permeability modifiers, resins, particulate materials (e.g., proppant particulates), wetting agents, coating enhancement agents, filter cake removal agents, and the like. A person skilled in the art, with the benefit of this disclosure, will recognize the types of additives that may be included in the fluids of the present disclosure for a particular application.

The methods and compositions of the present disclosure may be used during or in conjunction with any subterranean operation. Suitable subterranean operations may include, but are not limited to, preflush treatments, afterflush treatments, drilling operations, hydraulic fracturing treatments, sand control treatments (e.g., gravel packing), acidizing treatments (e.g., matrix acidizing or fracture acidizing), “frac-pack” treatments, well bore clean-out treatments, and other operations where a treatment fluid or inhibitor of the present disclosure may be useful. In certain embodiments, the methods and/or compositions of the present disclosure may be used in near well bore clean-out operations, wherein a treatment fluid of the present disclosure may be circulated in the subterranean formation, thereby suspending or solubilizing particulates residing in the formation. The treatment fluid then may be recovered out of the formation, carrying the suspended or solubilized particulates with it. In certain embodiments, a tagged inhibitor of the present disclosure may be pumped into a portion of a subterranean formation (e.g., a fracture) where the fluid may leak off into the formation faces near the well bore, forming a reservoir of inhibitor near the well bore. When fluids (e.g., hydrocarbons) are produced back out of the well bore, the inhibitor may slowly feed into the oil being produced. In certain embodiments, the methods and/or compositions of the present disclosure may be used in construction and/or operation of pipelines (e.g., transportation pipelines, distribution pipelines, etc.) or umbilical equipment that may be used, among other purposes, to transport various fluids (e.g., treatment fluids and/or fluids produced from subterranean formations).

The inhibitors of the present disclosure may be introduced into a subterranean formation, a well bore penetrating a subterranean formation, tubing, and/or pipeline using any method or equipment known in the art. Introduction of the inhibitors of the present disclosure may in such embodiments include delivery via any of a tube, umbilical, pump, gravity, and combinations thereof. An inhibitor of the present disclosure may, in various embodiments, be delivered downhole (e.g., into the wellbore) or into top-side flowlines/pipelines or surface treating equipment. For example, these inhibitors may be applied to a subterranean formation and/or well bore using batch treatments, squeeze treatments, continuous treatments, and/or combinations thereof. In certain embodiments, a batch treatment may be performed in a subterranean formation by stopping production from the well and pumping a specific amount or quantity of the tagged inhibitor into a well bore, which may be performed at one or more points in time during the life of a well. In other embodiments, a squeeze treatment may be performed by dissolving the tagged inhibitor in a suitable solvent at a suitable concentration and squeezing that solvent carrying the inhibitor downhole into the formation, allowing production out of the formation to bring the tagged inhibitor to its desired location. In still other embodiments, a tagged inhibitor of the present disclosure may be injected into a portion of a subterranean formation using an annular space or capillary injection system to continuously introduce the inhibitor into the formation. Other means and/or equipment that may be used to continuously inject a tagged inhibitor of the present disclosure into a well bore include, but are not limited to slip-stream systems, annulus drip systems, cap strings, umbilical strings, gas lift systems, continuous metering systems, subsurface hydraulic systems, bypass feeders, and the like. In certain embodiments, such continuous injection equipment at a well site may be controlled from a remote location and/or may be partially or completely automated. In certain embodiments, a treatment fluid comprising a tagged inhibitor of the present disclosure may be circulated in the well bore using the same types of pumping systems and equipment at the surface that are used to introduce treatment fluids or additives into a well bore penetrating at least a portion of the subterranean formation. In certain embodiments, an inhibitor of the present disclosure could be dried and formed into a solid for delivery into rat holes, tanks, and/or a wellbore.

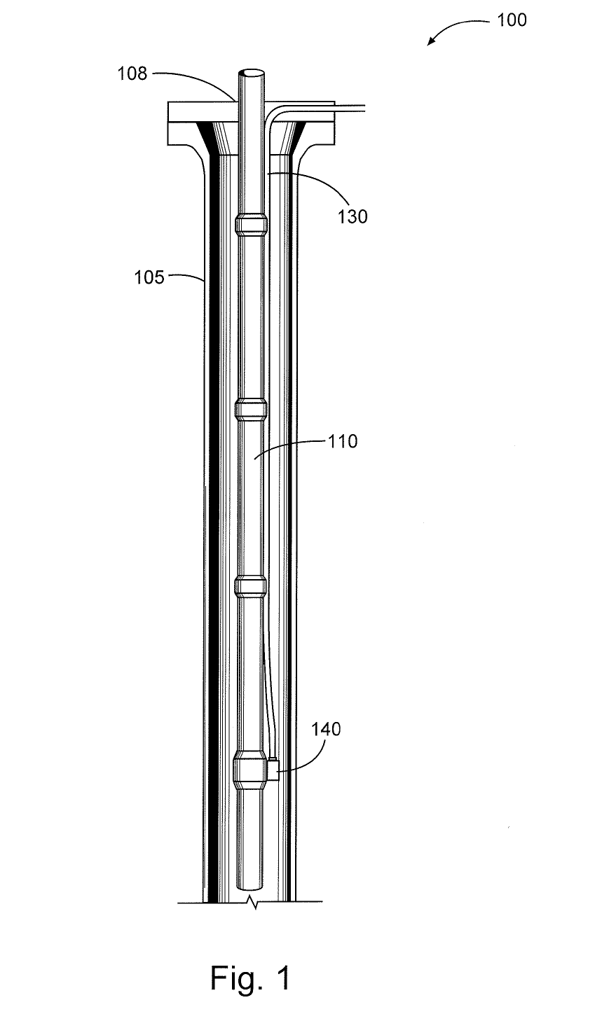

For example, a tagged inhibitor of the present disclosure may be introduced into a well bore using a capillary injection system as shown in FIG. 1. Referring now to FIG. 1, well bore 105 has been drilled to penetrate a portion of a subterranean formation 100. A tubing 110 (e.g., production tubing) has been placed in the well bore 105. A capillary injection tube 130 is disposed in the annular space between the outer surface of tubing 110 and the inner wall of well bore 105. The capillary injection tube 130 is connected to a side-pocket mandrel 140 at a lower section of the tubing 110. A tagged inhibitor may be injected into capillary injection tube 130 at the wellhead 108 at the surface (e.g., using one or more pumps (not shown)) such that it mixes with production fluid at or near the side-pocket mandrel 140. The system shown in FIG. 1 also may include one or more valves (not shown) at one or more locations along the capillary injection tube 130, among other reasons, to prevent flowback of fluid or gas to the surface through the tube. As the production fluid flows through the tubing 110, the tagged inhibitor may inhibit the deposition of paraffin wax and/or asphaltenes on the inner surfaces of tubing 110. Other capillary injection systems and side pocket mandrel devices (e.g., those used in gas lift production) may be used in a similar manner to the system shown in FIG. 1.

In certain embodiments, a tagged inhibitor of the present disclosure may be added to a pipeline where one or more fluids enter the pipeline and/or at one or more other locations along the length of the pipeline. In these embodiments, the tagged inhibitor may be added in batches or injected substantially continuously while the pipeline is being used.

Once introduced into a treatment fluid, subterranean formation, well bore, pipeline, or other location, the tagged inhibitors of the present disclosure may be detected or traced in fluid samples taken from any location where the tagged inhibitor is believed to be. For example, where the tagged inhibitor is introduced into a subterranean formation or well bore, fluid samples may be taken at the surface (e.g., at a well head) and/or one or more downhole locations. Where tagged inhibitor is introduced into a pipeline, fluid samples may be taken at one or more locations along the pipeline. The fluid samples may be analyzed using any technique known in the art for detecting the detectable element or functional group (e.g., standard water analysis techniques), which may be conducted at the site where the samples were taken or at an offsite location. Examples of analysis techniques that may be suitable in certain embodiments of the present disclosure include, but are not limited to, inductively coupled plasma optical emission spectrometry (ICP-OES) or inductively coupled plasma atomic emission spectroscopy (ICP-AES), liquid or gas chromatography (e.g., HPLC), mass spectroscopy, or any combination thereof.

The data generated in this analysis may be used determine the presence and/or concentration of a tagged inhibitor of the present disclosure. That data may be used to determine, among other things, whether an obstruction may be preventing fluid and inhibitor from flowing to the sampled location, and/or whether additional inhibitors should be added (e.g., if the concentration of the tagged inhibitor is less than a predetermined effective amount necessary to sufficiently inhibit paraffin and/or asphaltene precipitation). Where a tagged inhibitor of the present disclosure is applied in a batch treatment, the data generated in this analysis may be used to determine a residual concentration of the inhibitor after a certain period of time has passed since the last batch treatment. In certain embodiments, this data also may be used to infer the presence and/or location of additional additives (e.g., paraffin and/or asphaltene inhibitors) that are not tagged with a detectable element or functional group that were mixed and/or injected with a tagged inhibitor of the present disclosure. In certain embodiments, an operator or technician may use some or all of this data to assess whether the inhibitors are being applied in a particular operation in sufficient concentrations and/or sufficiently frequently (e.g., where batch treatments are used) to provide the desired level of paraffin and/or asphaltene inhibition. Based at least in part on this data, an operator or user may select or adjust the concentration of an inhibitor to use, for example, in an ongoing continuous treatment and/or in a subsequent batch treatment. Based at least in part on this data, an operator or user also may select and/or adjust the frequency and/or timing for a subsequent batch treatment of an inhibitor. In certain embodiments, such subsequent treatments may use a tagged inhibitor of the present disclosure and/or any other paraffin or asphaltene inhibitor known in the art.

In certain embodiments, the data generated in this analysis may be stored electronically and/or loaded into a database (e.g., an online database accessible from remote locations) for access by operators and/or technicians who may use that data to assess various conditions and treatment plans. One example of such a database where this data may be loaded and accessed is the MVP 2.0™ database available from Multi-Chem, a division of Halliburton Energy Services.

An embodiment of the present disclosure is a method comprising: providing a tagged inhibitor that comprises a base compound capable of inhibiting precipitation of paraffins or asphaltenes bonded with a detectable moiety; and introducing the tagged inhibitor into at least a portion of a subterranean formation.

Another embodiment of the present disclosure is a method comprising: providing a tagged inhibitor that comprises a base compound capable of inhibiting the precipitation of paraffins or asphaltenes bonded with a detectable moiety; and introducing the tagged inhibitor into at least a portion of a pipeline carrying one or more fluids from one location along the pipeline to another location along the pipeline.

Another embodiment of the present disclosure is a method comprising: providing a tagged inhibitor that comprises a maleic anhydride copolymer bonded with a detectable moiety comprising phosphorous; introducing the tagged inhibitor into at least a portion of a subterranean formation; and using inductively coupled plasma optical emission spectrometry to determine a concentration of the tagged inhibitor in a sample of fluid from at least a portion of the subterranean formation.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method comprising:
providing a tagged inhibitor that comprises a base compound capable of inhibiting precipitation of paraffins or asphaltenes bonded with a detectable moiety; and
introducing the tagged inhibitor into at least a portion of a subterranean formation.

2. The method of claim 1 further comprising analyzing a sample of fluid from at least a portion of the subterranean formation to determine a concentration of the tagged inhibitor in the fluid.

3. The method of claim 2 wherein an inductively coupled plasma optical emission spectrometry technique is used to analyze the fluid sample.

4. The method of claim 2 wherein:
the concentration of the tagged inhibitor in the fluid sample is less than a predetermined effective amount; and
the method further comprises introducing an additional paraffin or asphaltene inhibitor into at least a portion of the subterranean formation.

5. The method of claim 4 wherein the additional paraffin or asphaltene inhibitor comprises an additional tagged paraffin or asphaltene inhibitor.

6. The method of claim 1 wherein a well bore penetrates the portion of the subterranean formation, and at least a portion of tubing resides in the well bore.

7. The method of claim 1 wherein introducing the tagged inhibitor into at least a portion of the subterranean formation comprises injecting the tagged inhibitor into a capillary injection tube disposed in a well bore that penetrates at least a portion of the subterranean formation.

8. The method of claim 1 wherein the base compound comprises a maleic anhydride copolymer.

9. The method of claim 1 wherein the base compound comprises a polyacrylate.

10. The method of claim 1 wherein the detectable moiety comprises at least one element selected from the group consisting of: boron, phosphorus, bromine, iodine, selenium, and any combination thereof.

11. A method comprising:
providing a tagged inhibitor that comprises a base compound capable of inhibiting the precipitation of paraffins or asphaltenes bonded with a detectable moiety; and
introducing the tagged inhibitor into at least a portion of a pipeline carrying one or more fluids from one location along the pipeline to another location along the pipeline.

12. The method of claim 11 further comprising analyzing a sample of fluid from at least a portion of the pipeline to determine a concentration of the tagged inhibitor in the fluid.

13. The method of claim 12 wherein an inductively coupled plasma optical emission spectrometry technique is used to analyze the fluid sample.

14. The method of claim 12 wherein:
the concentration of the tagged inhibitor in the fluid sample is less than a predetermined effective amount; and
the method further comprises introducing an additional paraffin or asphaltene inhibitor into at least a portion of the pipeline.

15. The method of claim 11 wherein the base compound comprises a maleic anhydride copolymer.

16. The method of claim 11 wherein the base compound comprises a polyacrylate.

17. The method of claim 11 wherein the detectable moiety comprises at least one element selected from the group consisting of: boron, phosphorus, bromine, iodine, selenium, and any combination thereof.

18. A method comprising:
providing a tagged inhibitor that comprises a maleic anhydride copolymer bonded with a detectable moiety comprising phosphorous;
introducing the tagged inhibitor into at least a portion of a subterranean formation; and
using inductively coupled plasma optical emission spectrometry to determine a concentration of the tagged inhibitor in a sample of fluid from at least a portion of the subterranean formation.

19. The method of claim 18 wherein:
the concentration of the tagged inhibitor in the fluid sample is less than a predetermined effective amount; and
the method further comprises introducing an additional paraffin or asphaltene inhibitor into at least a portion of the subterranean formation.

20. The method of claim 18 wherein introducing the tagged inhibitor into at least a portion of the subterranean formation comprises injecting the tagged inhibitor into a capillary injection tube disposed in a well bore that penetrates at least a portion of the subterranean formation.
